(19) United States
(12) Patent Application Publication
(10) Pub. No.: US 2002/0155884 A1
(43) Pub. Date: Oct. 24, 2002

(54) Accounting method and apparatus for fair peer-to-peer gambling

(76) Inventor: Kim Updike, Tinley Park, IL (US)

Correspondence Address: MARSHALL, GERSTEIN & BORUN, 6300 SEARS TOWER, 233 SOUTH WACKER, CHICAGO, IL, 60606-6357, US

(21) Appl. No.: 09/840,574

(22) Filed: Apr. 23, 2001

(51) Int. Cl. G06F 17/00

(52) U.S. Cl. 463/25

(57) ABSTRACT

Apparatus and methods for fair peer-to-peer gambling is disclosed. Generally, the system receives a bet statement from one of two authorized players. Either one of the two authorized players then enters a whole number percentage representing his belief that the outcome of the bet statement will be true. The player entering the risk percentage is encouraged to be as fair as possible, because the other player chooses which side of the bet he will take, thereby forcing the first player into the other position. The amount of points or money wagered are then automatically determined based on the risk percentage and a predetermined scaling scheme which limits potential gambling losses to levels deemed acceptable by the players. Once the actual outcome is determined, the winning player is rewarded in inverse proportion to his risk percentage. In other words, a winning player who is favored to win receives less than a winning player who is not favored to win. The winning points are preferably subtracted from the loser's account and added to the winner's account without a “house cut.”

### TECHNICAL FIELD

The present invention relates in general to gambling systems and, in particular, to accounting methods and apparatus for fair peer-to-peer gambling.

### BACKGROUND

Many people like to gamble, and many of the games they play are electronic. Some are “stand alone” games, others are Internet based games. However, established electronic wagering systems present predetermined games known to a large percentage of the population. For example, blackjack, poker, roulette, and slots may be played electronically. The odds and payouts for these games are normally predetermined by the game manufacturer. Typically, the odds are in favor of the “house,” and there is no option to play fair odds against another player who is not the house.

Of course, many bets are made every day between two players without a “house.” For example, two friends may wager on the outcome of a coin toss or a football game. However, if the subject of the bet is not a common one, there is no convenient way for the players to determine, express, and/or communicate what odds are fair. Determining the odds for coin tosses and football games is easy. Everybody knows the fair odds for a coin toss are 50-50. Similarly, professional odds makers establish point spreads for football games to make the odds of wining or losing as close to 50% as they can. But if two people want to bet on something “odd,” like the high temperature in Maui on New Years Day or the box office take of the next Stephen Spielberg movie, fair odds are difficult to determine.

In addition, the payout for the typical two person bet is always the same regardless of who is the winner and who is the loser. For example, if Alan bets Bob $100 that the Rams will beat the Vikings by seven points, Alan will either win $100 or he will lose $100, and the same is true for Bob. The amount is the same, only the direction of the money flow changes. This is fair for these “normal” bets, because the odds of winning are the same as the odds of losing (i.e., 50%). However, if the agreed upon odds that “Madonna will win a Grammy in 2001” are 68% “yes” and 32% “no,” then risking the same amount of money for both sides is unfair. Nobody will want to take the “no” position, because there is no spread to even the odds. The perceived risk is not consistent with the reward, and negotiating/calculating fair odds is time consuming and awkward. As a result, people tend to shy away from these types of otherwise interesting bets.

### BRIEF DESCRIPTION OF THE DRAWINGS

Features and advantages of the disclosed system will be apparent to those of ordinary skill in the art in view of the detailed description of exemplary embodiments which is made with reference to the drawings, a brief description of which is provided below.

FIG. 1 is a high level block diagram of a network communications system employing an embodiment of the present invention.

FIG. 2 is a more detailed block diagram of one of the client devices illustrated in FIG. 1.

FIG. 3 is a more detailed block diagram showing one embodiment of the game server illustrated in FIG. 1.

FIG. 4 is a more detailed block diagram showing another embodiment of the game server illustrated in FIG. 1.

FIG. 5 is a flowchart of a process for facilitating fair peer-to-peer gambling.

### DETAILED DESCRIPTION OF EXEMPLARY EMBODIMENTS

In general, the apparatus and methods described herein facilitate fair peer-to-peer gambling. Generally, the system receives a bet statement from one of two authorized players. Either one of the two authorized players then enters a whole number percentage representing his belief that the outcome of the bet statement will be true. The player entering the risk percentage is encouraged to be as fair as possible, because the other player chooses which side of the bet he will take, thereby forcing the first player into the other position. The amount of points or money wagered are then automatically determined based on the risk percentage and a predetermined scaling scheme which limits potential gambling losses to levels deemed acceptable by the players. Once the actual outcome is determined, the winning player is rewarded in inverse proportion to his risk percentage. In other words, a winning player who is favored to win receives less than a winning player who is not favored to win. Preferably, the winning points are subtracted from the loser's account and added to the winner's account without a “house cut.” Of course, a person of ordinary skill in the art will readily appreciate that one of the players may be a casino, another gaming establishment, and/or a computing device. However, in such an instance, the “house” only receives funds if the house wins the bet and/or subscription fees are charged.

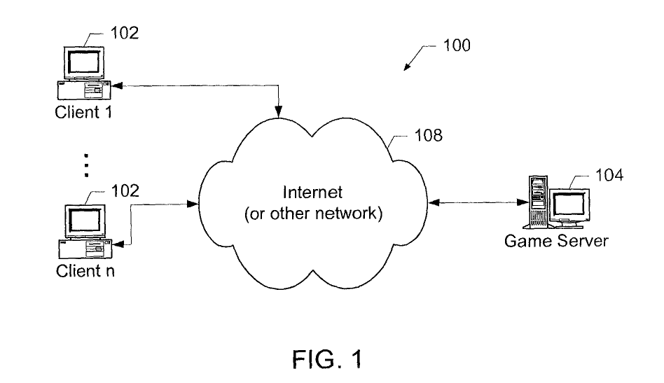

A high level block diagram of an exemplary network communications system 100 capable of employing the teachings of the present invention is illustrated in FIG. 1. Typically, the system 100 includes one or more client devices 102 and one or more game servers 104. Each of these devices may communicate with each other via a connection to the Internet or some other wide area network 108. Of course, a person of ordinary skill in the art will readily appreciate that local area networks and/or direct wired or wireless connections may also be used without departing from the scope and spirit of the present invention. For example, two bar patrons may bet against each other using one or more hand-held devices such as a PDA or cellular telephone.

Typically, game servers 104 store a plurality of files, programs, and/or web pages for use by the client devices 102. One game server 104 may handle requests from a large number of clients 102. Accordingly, each server 104 is typically a high end computer with a large storage capacity, one or more fast microprocessors, and one or more high speed network connections. Conversely, relative to a typical server 104, each client device 102 typically includes less storage capacity, a single microprocessor, and a single network connection.

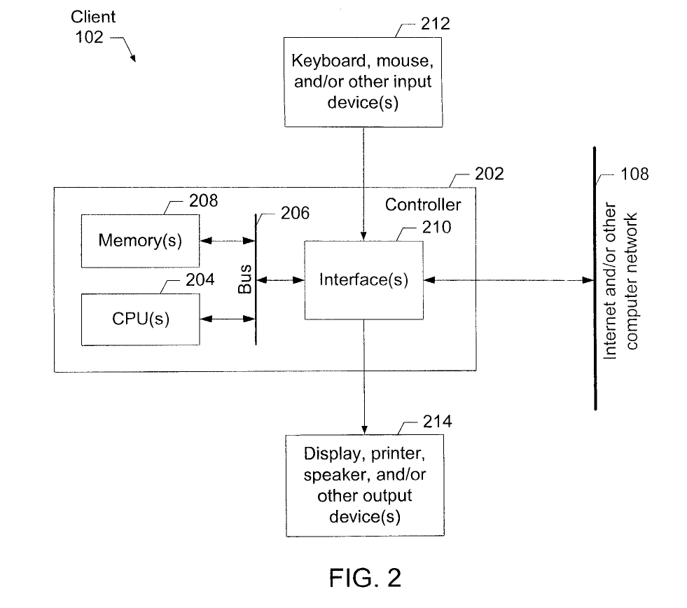

A more detailed block diagram of a client device 102 is illustrated in FIG. 2. The client device may be a personal computer (PC), a personal digital assistant (PDA), a cellular telephone, an Internet appliance, a dedicated stand-alone gambling device, and/or any other electronic device. The client 102 includes a controller 202 which preferably includes a central processing unit 204 electrically coupled by an address/data bus 206 to a memory device 208 and an interface circuit 210. The CPU 204 may be any type of well known CPU, such as an Intel Pentium TM processor. The memory device 208 preferably includes volatile memory and non-volatile memory. Preferably, the memory device 208 stores a software program that interacts with the game server 104 as described below. This program may be executed by the CPU 204 in a well known manner. The memory device 208 may also store digital data indicative of documents, files, programs, web pages, etc. retrieved from a game server 104 and/or loaded via an input device 212.

The interface circuit 210 may be implemented using any type of well known interface standard, such as an Ethernet interface and/or a Universal Serial Bus (USB) interface. One or more input devices 212 may be connected to the interface circuit 210 for entering data and commands into the controller 202. For example, the input device 212 may be a keyboard, mouse, touch screen, track pad, track ball, isopoint, and/or a voice recognition system.

One or more displays, printers, and/or other output devices 214 may also be connected to the controller 202 via the interface circuit 210. The display 214 may be cathode ray tube (CRTs), liquid crystal displays (LCDs), or any other type of display. The display 214 generates visual displays of data generated during operation of the client 102. The display 214 is typically used to display web pages received from the game server 104. The visual displays may include prompts for human operator input, run time statistics, calculated values, detected data, etc.

The client 102 may also exchange data with other devices via a connection to the network 108. The network connection may be any type of network connection, such as an Ethernet connection, digital subscriber line (DSL), telephone line, coaxial cable, Bluetooth connection, etc. Users of the system 100 may be required to register with the game server 104. In such an instance, each user may choose a user identifier and a password which may be required for the activation of services. The user identifier and password may be passed across the Internet 108 using encryption built into the user's browser. Alternatively, the user identifier and/or password may be assigned by the game server 104.

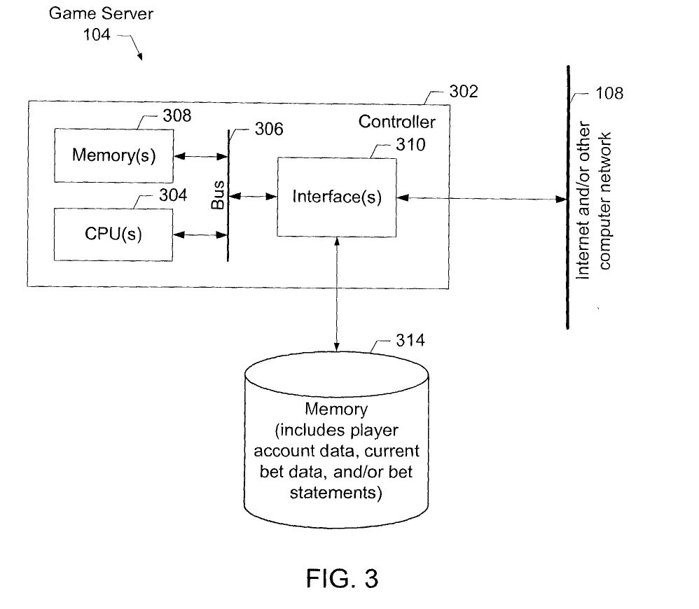

A more detailed block diagram of a game server 104 is illustrated in FIG. 3. Like the client device 102, the controller 302 in the server 104 preferably includes a central processing unit 304 electrically coupled by an address/data bus 306 to a memory device 308 and a network interface circuit 310. However, the sever controller 302 is typically more powerful than the client controller 202. Again, the CPU 304 may be any type of well known CPU, such as an Intel PentiumTM processor, and the memory device 308 preferably includes volatile memory and non-volatile memory. Preferably, the memory device 308 stores a software program that implements all or part of the method described below. This program may be executed by the CPU 304 in a well known manner. However, some of the steps described in the method below may be performed manually or without the use of the server 104. The memory device 308 and/or a separate database 314 also store files, programs, web pages, etc. for use by the client devices 102.

The server 104 may exchange data with other devices via a connection to the network 108. The network interface circuit 310 may be implemented using any data transceiver, such as an Ethernet transceiver. The network 108 may be any type of network, such as a local area network (LAN) and/or the Internet.

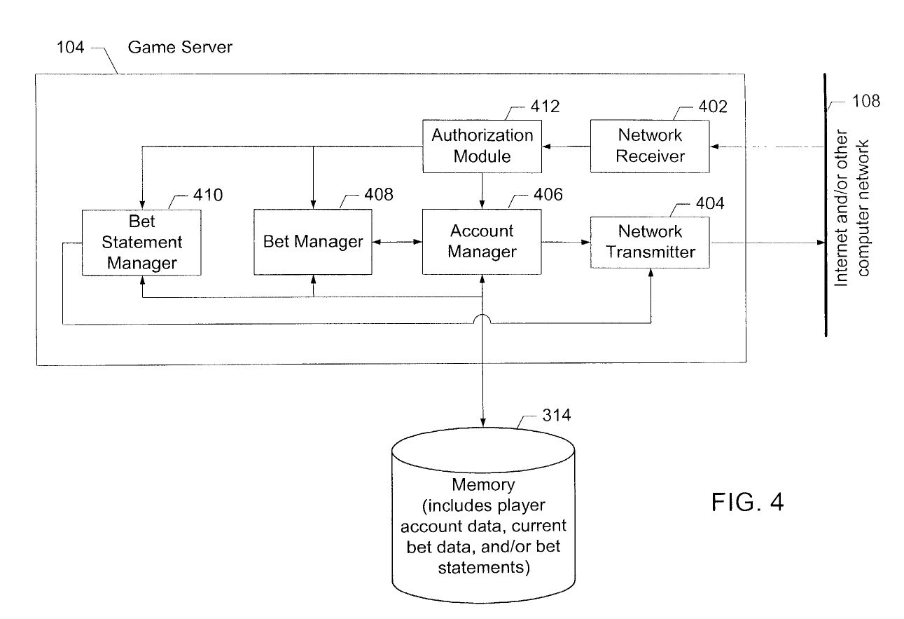

A more detailed block diagram of another embodiment of the game server 104 is illustrated in FIG. 4. In this embodiment, the game server 104 includes a receiver 402, a transmitter 404, an account manager 406, a bet manager 408, a bet statement manager 410, and an authorization module 412. Each of these blocks may be implemented by a microprocessor executing software instructions and/or conventional electronic circuitry. In addition, a person of ordinary skill in the art will readily appreciate that certain blocks may be combined or divided according to customary design constraints. Although the wagering system is described herein as client/server based, a person of ordinary skill in the art will readily appreciate that a stand-alone version of the wagering system may also be used. In such an instance, the operations described below as being performed by the game server 104 may be performed locally by a client device 102.

For the purpose of receiving web page requests, player account data, bet statements, bet data, user names, passwords, and other data, the game server 104 includes the network receiver 402. The network receiver 402 is operatively coupled to the network 108 in a well known manner. For example, the network receiver 402 may be an Ethernet interface circuit electrically coupled to the Internet via an Ethernet cable.

Player account data preferably includes account numbers and associated point totals. In some embodiments, the points may represent money. For example, 0.01 points may represent one penny or one dollar. Alternatively, well known credit card accounts may be used. Bet statements are preferably text based statements that indicate what the bet is (e.g., “Madonna will win a Grammy in 2001”). Bet statements may be selected from a database of bet statements by the players, and/or bet statements may be entered by the players. Bet data preferably include one or more risk percentages, position indicators, and outcome indicators. For example, player one may indicate that he thinks there is a 60% chance that Madonna will win a Grammy in 2001 (risk percentage=60%). Player two may take the “positive” or “yes” position (i.e., player two thinks there is at least a 60% chance that Madonna will win a Grammy in 2001), thereby forcing player one into the “negative” or “no” position (i.e., player one wins if Madonna does not win a Grammy in 2001). Preferably, players take turns setting risk percentages and selecting bet positions (e.g., player one sets the risk percentages for odd numbered bets). If the actual outcome is that Madonna does win a Grammy in 2001 (outcome indicator=positive), then player two wins. However, player two only wins 0.4 points (or some near multiple thereof), because player two was favored to win. On the other hand, if player one wins (Madonna does not win a Grammy in 2001), player one will receive 0.6 points (or some near multiple thereof), because player one was not favored to win.

For the purpose of transmitting web pages, player account data, bet statements, bet data, and other data, the game server 104 includes the network transmitter 404. The network transmitter 404 is operatively coupled to the network 108 in a well known manner. For example, the network transmitter 404 may also be an Ethernet interface circuit electrically coupled to the Internet via an Ethernet cable.

For the purpose of storing player account data, bet statements, bet data, user names, passwords, and other data, the game server 104 includes a memory device 314. Preferably, the memory device 314 is operatively coupled to the account manager 406, the bet manager 408, and/or the bet statement manager 410. The memory device 314 may be a single memory device or a combination of memory devices. The memory device 314 may be volatile memory, non-volatile memory, or a combination of volatile and non-volatile memory. The memory device 314 may be a local memory device, a remote memory device, or a combination of local and remote memory devices. For example, player account data may be stored remotely at a financial institution or locally as points. Bet statements may be stored in a database located near the game server 104, and/or bet statements may be stored in a memory associated with one or more clients 102.

For the purpose of managing account data associated with a plurality of players, the game server 104 includes the account manager 406. Preferably, the account manager 406 is operatively coupled to the transmitter 404, the receiver 402, and the memory device 314. Preferably, the account manager 406 stores/retrieves player account data to/from the memory device 314. After each round of betting, the account manager 406 subtracts points from a player account associated with a losing position and adds the same number of points to a player account associated with a winning position. In addition, the account manager 406 may cause the transmitter to transmit the player account data over the computer network 108. For example, after a round of betting in which player one lost and player two won, the account manager 406 may subtract a certain number of points from player one's account, add those points to player two's account, transmit player one's new account status to a client device 102 associated with player one (e.g., update a web page for player one), and transmit player two's new account status to another client device 102 associated with player two (e.g., update a different web page for player two). Of course, both player's could be sent the same information or both players could be at the same client device 102.

For the purpose of managing bets between players, the game server 104 includes the bet manager 408. Preferably, the bet manager 408 is operatively coupled to the receiver 402, the memory device 314, and the account manager 406. Preferably, the bet manager 408 receives a first risk percentage from the receiver 402 and then determines a second risk percentage such that the sum of the first risk percentage and the second risk percentage is equal to 100%. For example, if the first risk percentage is 75%, then the second risk percentage is determined to be 25% by subtracting 75 from 100. The bet manager 408 may then store the risk percentages in the memory device 314.

Subsequently, the bet manager 408 preferably receives a position indicator. The position indicator identifies an association between one of the player accounts and one of the risk percentages. After the event which is the subject of the bet has past, the bet manager 408 receives an outcome indicator from the receiver 402. The outcome indicator identifies one of the risk percentages as the winning position. The bet manager 408 then causes the account manager 406 to subtract an amount from the losing player's account and add that amount to the winning player's account. Preferably, the bet manager performs these tasks for a series of bets (i.e., a game).

For example, player one may place the odds at 60%, which indicates that he thinks there is a 60% chance that Madonna will win a Grammy in 2001 (risk percentage=60%). Player two may take the “positive” position (i.e., player two thinks there is at least a 60% chance that Madonna will win a Grammy in 2001), thereby forcing player one into the “negative” position (i.e., player one wins if Madonna does not win a Grammy in 2001). If the actual outcome is that Madonna does win a Grammy in 2001 (outcome indicator=positive), then player two wins. As a result, 0.4 points (or some near multiple thereof) are subtracted from player one's account and added to player two's account.

For the purpose of managing bet statements, the game server 104 includes a bet statement manager 410. Preferably, the bet statement manager 410 is operatively coupled to the transmitter 404, the receiver 402, and the memory device 314. Preferably, the bet statement manager 410 receives bet statements from the receiver 402, stores the bet statements in the memory 314, retrieves the received bet statements and/or “canned” bet statements from the memory 314, and causes the transmitter 404 to transmit one or more bet statements over the computer network 108. Bet statements are preferably text based statements that indicate what the bet is (e.g., “Madonna will win a Grammy in 2001”). Preferably, bet statements are complete sentences stated in the positive (as opposed to negative or double negative statements). In addition, bet statements are preferably unambiguous with a clear easily determined, quantifiable outcome. Bet statements may be selected from a database of “canned” bet statements, and/or bet statements may be entered by the players. In one embodiment, the players simply keep track of the bet statements orally and/or with the aid of a written record. In such an instance, the bet statement manager may be eliminated without departing from the scope and spirit of the present invention.

For the purpose of providing security to player account data, the game server 104 includes an authorization module 412. The authorization module 412 is operatively coupled to the receiver 402, the account manager 406, the bet manager 408, and/or the bet statement manager 410. The authorization module 412 receives a user name and/or password from the receiver 402 and determines if the user name and/or password is associated with a player account.

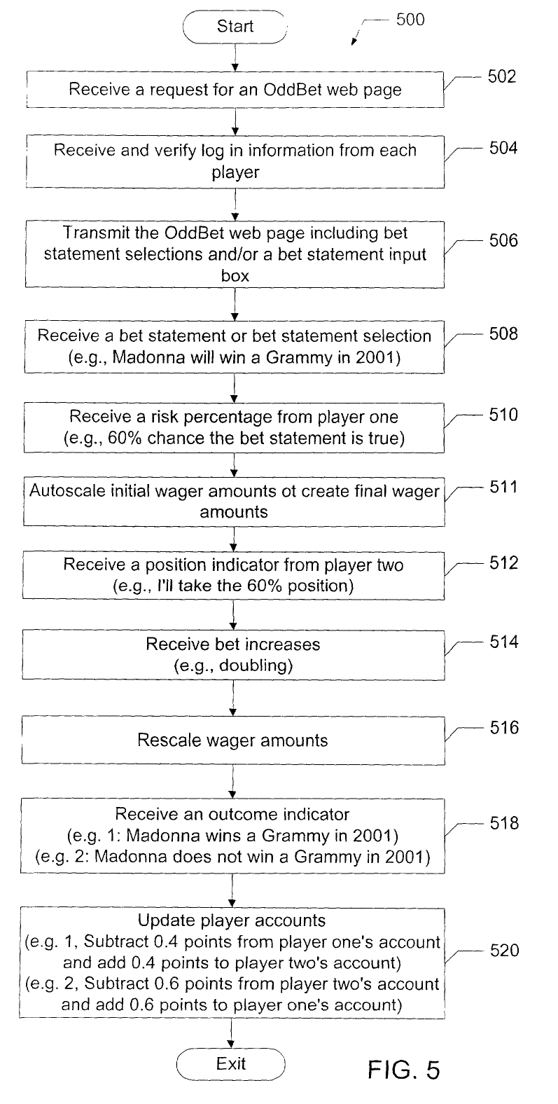

A flowchart of a process 500 for facilitating fair peer-to-peer gambling is illustrated in FIG. 5. Preferably, the process 500 is embodied in a software program which is stored in the game server memory 308 and executed by the game server CPU 304 in a well known manner. However, some or all of the steps of the process 500 may be performed manually and/or by another device. Although the process 500 is described with reference to the flowchart illustrated in FIG. 5, a person of ordinary skill in the art will readily appreciate that many other methods of performing the acts associated with process 500 may be used. For example, the order of many of the steps may be changed without departing from the scope or spirit of the present invention. In addition, many of the steps described are optional.

Generally, the process 500 receives a bet statement from one of two authorized players (e.g., “Madonna will win a Grammy in 2001). Either one of the two authorized players then enters a whole number percentage representing his belief that the outcome of the bet statement will be true. For example, player one may indicate that he thinks there is a 60% chance that Madonna will win a Grammy in 2001. The player entering the risk percentage is encouraged to be as fair as possible, because the other player chooses which side of the bet he will take. For example, player two may take the “positive” position (i.e., player two also thinks there is a 60% chance that Madonna will win a Grammy in 2001), thereby forcing player one into the “negative” position (i.e., player one wins if Madonna does not win a Grammy in 2001). If the actual outcome is that Madonna does win a Grammy in 2001, then player two wins. However, player two only wins 0.4 points (or some multiple thereof), because player two was favored to win. On the other hand, if player one wins (Madonna does not win a Grammy in 2001), player one will receive 0.6 points (or some multiple thereof), because player one was not favored to win. In other words, the reward always automatically and fairly matches the risk as perceived by the odds setter. Although, for clarity in description, only one bet is shown, a person of ordinary skill in the art will readily appreciate that entire games (i.e., a series of bets) may be played according to the method described herein without departing from the scope or spirit of the present invention.

The process 500 begins when the game server 104 receives a request for one or more OddBet web pages from a player via the network 108 (step 502). However, as discussed above, the OddBet system need not be carried out over the Internet if a stand-alone device is used. Some OddBet web pages preferably require a username and/or a password (step 504). Once the server 104 receives the username and password, the server program 500 verifies that the username and password belong to a registered OddBet player by checking the database 314 (step 504). Similarly, a second OddBet player logs in using a different username and password. If the two OddBet players are competing from separate client devices 102.

The server program 500 then transmits one or more web pages to the players for display at the players' client devices 102 (step 506). Preferably, the server program 500 starts by transmitting a “home” page. The home page is typically the top level in a hierarchical collection of related web pages at a particular web site. The majority of these related web pages are typically served from the same network domain (e.g., OddBet.com). After receiving the home page, the clients 102 may request additional web pages from the web site by selecting hyperlinks embedded in previously received web pages in a well known manner. Preferably, at least one of the transmitted web pages includes a plurality of bet statement selections and/or a bet statement input box.

Subsequently, one of the players selects one or more bet statements from the plurality of bet statement selections and transmits data indicative of the selection to the game server 104 (step 508). Alternatively, one of the players transmits one or more complete bet statements to the game server 104. In addition, a bet statement may be associated with an initial wager amount. Alternatively, the initial wager amount may be preset and/or entered separately.

Once one or more bet statements are set, one of the players transmits a risk percentage(s) to the game server 104 (step 510). Preferably, the risk percentage is entered into a web page input box as a whole number percentage (e.g., 1%-99%). The risk percentage is preferably associated with the positive outcome of the bet statement, but may be associated with the negative outcome of the bet statement if so indicated by the player submitting the risk percentage.

Often, an individual cannot tolerate a large loss as easily as a gambling house. Accordingly, the server 10 may automatically and consistently scale the initial wager amount down to a final wager amount as odds grow longer or more extreme (step 511). However, the system maintains a fair risk-reward relationship. In one embodiment, form fields enable players to enter loss cap agreements per bet and/or per game. Preferably, an error message prevents any inputs in the bet process that could result in violation of the player-set loss caps. In this embodiment, the players would have to change the cap field by mutual agreement before the system would enable a bet action that violated the initial cap field setting. As a result of these loss control measures, users waste less time haggling or worrying about setting the final wager amount (i.e., the stake) and more time negotiating fair and affordable odds and payoffs. Scaling the initial wager amount down to a final wager amount on long odds (i.e., automatically lowering bets to affordable limits) can be done through player agreement in at least four different ways. In addition, it will be understood throughout the description that any wager amount may be multiplied by some constant (e.g., $2) without departing from the scope and spirit of the present invention. For example, a final wager amount of 0.75 may represent $1.50.

The straight sliding amount scale: This type of scaling dramatically decreases the initial wager amount on bets with long odds. Preferably, the straight amount scale is the default scale, and a good scale for beginners because it is the easiest to understand. At one extreme, the 50% to 50% chance bet has a final wager amount of 0.5 for both players. At the other extreme, a 1% to 99% change bet has a final wager amount of 0.01 for one player and 0.99 for the other player, which means the relative wager amount is only 2% the wager amount of a 50% to 50% even bet. Using this scale, the final wager amounts are proportional and match the numerals that represent the opposite side of the odds. For example, the 11% to 89% odds bet has a final wager amount of 0.89 if you were on the side of the bet with only an 11% probability of winning.

The no slide scale: Using another type of scaling, the final wager amount does not decrease disproportionately as the odds grow longer. If a player is on the high (or even) probability (i.e., safe) side of a bet, he will always have a final wager amount of 0.5 points (unless players use their options to double the bet). This scheme includes 50 different payout scenarios within a linear progression. At one extreme, the 50% to 50% chance bet has a final wager amount of 0.5 for both players. At the other extreme, a 1% to 99% chance bet has a final wager amount of 0.5 for one player and 49.5 for the other player. 2% to 98% odds create final wager amounts of 0.5 and 49. 3% to 97% odds create final wager amounts of 0.5 and 48.5. 49% to 51% odds create final wager amounts of 0.5 and 0.52. (Note that some of the final wager amounts are rounded by a very insignificant amount.)

The factor (e.g., of 10) sliding scale: This type of scaling is similar to the straight sliding amount scale described above, however, the final wager amounts associated with the 1% to 99% bet is multiplied by some factor such as ten. Therefore, the final wager is only 5 times rather than 50 times less than the amount wagered on an even bet. As a result, the losing player loses 0.5 points on an even bet and 0.1 points (or 9.9) on a 1% to 99% bet. Based on the two bet extremes (even and 1% to 99%), a linear expression sets the final wager amount for bets of other odds in an evenly distributed scale.

The incremental amount added for each 1% increase is determined by subtracting 0.1 from 0.5 to get 0.4. Next, 0.4 is divided by the 48 numbers between 1 and 50 to get the incremental amount of 0.008333333333. Preferably, games round to two decimal places. Accordingly, adding 0.008333333333 to 0.1 creates a final wager amount for a 98% likelihood of 0.11 point, or a loss of 5.39 [0.11×(98/2)]. As long as the final wager amounts are increased in proportion to the 2 to 98 ratio, the risk to reward relationship remains virtually the same.

The player defined scale: To use this scale, an administrator and/or the players must answer two questions during the setup of a game.

The first question is “What amount can you comfortably wager repeatedly during a series of even 50% to 50% bets?” The second question is “If you enter a 1% to 99% bet and you lose so that you have to pay your opponent 99 times what you would have collected, what is the amount you could comfortably pay out for such an unlikely large loss?” For example, a player might enter $1 as the average and $20 as the worse loss. How many bets are in the planned series is assumed to already be entered in the system. A formula then analyzes the three inputs to recommend a proper scaling method and bet doubling rules.

Either player may determine the bet statement, and either player may set the risk percentage. However, which ever player sets the risk percentage for a particular bet statement (e.g., player 1), the other player determines which side of that bet he will take (e.g., player 2). Accordingly, that player (e.g., player 2), transmits data indicative of his bet position to the server 104 (step 512). Alternatively, player 1 may enter data for player 2. Preferably, the players take turns setting the risk percentage (e.g., player one sets the risk percentage for odd numbered bets). In an alternate embodiment, one or both players may be required to submit data associated with one or more bets prior to a predetermined time limit. In this embodiment, faster players may be rewarded with additional points.

Subsequently, either player may increase the initial wager amount (step 514). For example, the player in the forced position may be allowed to double the wager amount. In addition, the player in the selected position may be allowed to double the wager amount (either initially or in addition to a previous doubling). In another embodiment, the players may negotiate one or more bet statements, risk percentages, bet positions, and/or bet increases.

In large group games, players may rank and/or weigh a plurality of bets to set various stakes. In such a large group game, more than one player may take the same bet position. Similarly, more than one player may be forced into the same bet position.

Once the risk percentages and wager amounts are known, the game server 104 may display an error message and/or automatically re-scale the wager amounts to limit a player's maximum loss (step 516). For example, if each percentage point represents two dollars, the odds are set at 60%-40%, and a player has previously indicated that he does not wish to risk more than $100 on any single bet, then the initial wager amount may be scaled from payouts of $80-$120 to payouts of $66.67-$100 respectively. Note, the final wager amounts must often be rounded (as in this example) to keep even dollar amounts. A person of ordinary skill in the art will readily appreciate that although this rounding affects the fairness of the bet to a minor degree, it does not depart from the scope and spirit of the present invention.

Once the event which is the subject of the bet statement has past, one or more of the players and/or a system administrator transmits an outcome indicator to the server 104 (step 518). Preferably, this is accomplished by recalling a record from the server 104 which indicates the bet statement, the risk percentages, and the positions taken. Next to the displayed record, the server 104 provides one button for indicating a positive outcome, and another button for indicating a negative outcome. Of course, a person of ordinary skill in the art will readily appreciate that many other methods of selecting between two possible choices using a web page are well known. For example, a check box may be used.

Once the server 104 receives the risk percentage, the position indicator, and the outcome indicator, the program 500 updates both player's accounts (step 520). Preferably, the number of points subtracted from the losers account is the same as the number of points that are added to the winners account. In other words, there is no “house cut.” In addition, the number of points added to the winner's account is inversely proportional to the risk percentage associated with the winner. Said another way, the number of points subtracted from the loser's account is directly proportional to the risk percentage associated with the loser. A winner who is expected to win (i.e., his risk percentage is greater than 50%) receives fewer points than a winner who wins against the odds (i.e., his risk percentage is less than 50%).

In another embodiment, two or more players compete against a plurality of players by comparing their independent scores. In this embodiment, the same complimentary odd setting and scoring methods are used except that points deducted from a player's score (i.e., account) are not then added to the score of an opponent. Similarly, points added to a player's score do not come from another player's score. In small group games, one or more of the players may serve as an administrator. Preferably, in large group games, a game administrator from the company that is providing the game service is used. The game administrator could set all bet statements and odds, or the players could play a role in setting bet statements and/or odds.

Players select their bet positions independently. Accordingly, more than one player may have the same position on a bet. Preferably, after choosing positions, a player in a large group game ranks his bets from best to worst. A more substantial relative bet increase or weight is then assigned according to ranks. For example, if there are 10 bets in the game the player rates the bet he likes the best a 10, the bet he like second best a 9 and so forth. The initial wager amount for the highest ranked bet is then multiplied by 10 (which is the player's assigned rank). The initial wager amount for the second highest ranked bet is multiplied by 9, and so on. Even if two players have identical positions on a series of bets, the rank and weighting system means that their scores could be far different. Final scores are the basis for determining a winner.

In summary, persons of ordinary skill in the art will readily appreciate that a method and apparatus for fair peer-to-peer gambling has been provided. Users of systems implementing the teachings described herein can enjoy fair wagers on classic or “odd” betting subjects with confidence that their reward or loss automatically and accurately reflects their perceived risk without the need for professional odds makers or cumbersome payout calculations. In addition, the players are given convenient automatic bet scaling options to limit wagered amounts to acceptable levels.

The foregoing description has been presented for the purposes of illustration and description. It is not intended to be exhaustive or to limit the invention to the exemplary embodiments disclosed. Many modifications and variations are possible in light of the above teachings. It is intended that the scope of the invention be limited not by this detailed description, but rather by the claims appended hereto.

What is claimed is:

1. A method of transferring points from a first player's game account to a second player's game account, the method comprising the steps of:
receiving data indicative of a first odds number, the first odds number representing a percentage of risk determined by the first player;
determining a second odds number such that the sum of the first odds number added to the second odds number is equal to 100%;
receiving scaling data indicative of at least one of a scaling type and a scaling factor;
determining a first number of points based on the scaling data and the first odds number;
determining a second number of points based on the scaling data and the second odds number;
receiving a position indicator, the position indicator representing an association between the second player and only one of the first odds number and the second odds number, the position indicator being selected by the second player;
receiving an outcome indicator, the outcome indicator representing a winning position, the winning position being associated with only one of the first odds number and the second odds number;
subtracting the first number of points from a first game account associated with the first player and adding the first number of points to a second game account associated with the second player if the position indicator is associated with the second odds number and the winning position is associated with the second odds number;
subtracting the second number of points from the first game account and adding the second number of points to the second game account if the position indicator is associated with the first odds number and the winning position is associated with the first odds number;
subtracting the first number of points from the second game account and adding the first number of points to the first game account if the position indicator is associated with the first odds number and the winning position is associated with the second odds number; and
subtracting the second number of points from the second game account and adding the second number of points to the first game account if the position indicator is associated with the second odds number and the winning position is associated with the first odds number.

2. A method as defined in claim 1, further comprising the steps of displaying a plurality of bet statements and receiving a selection identifying a particular bet statement from the plurality of bet statements.

3. A method as defined in claim 1, further comprising the step of receiving a text based bet statement.

4. A method as defined in claim 1, further comprising the steps of:
receiving a first user identifier associated with the first player;
receiving a first password associated with the first player;
receiving a second user identifier associated with the second player; and
receiving a second password associated with the second player.

5. A method as defined in claim 1, wherein the step of receiving data indicative of a first odds number comprises the step of receiving a whole number percentage less than 100%.

6. A method as defined in claim 1, wherein the step of subtracting the first number of points from a first game account comprises the step of subtracting digital data representing money from a first game account.

7. A method as defined in claim 6, further comprising the step of receiving a bet amount, wherein the step of determining a first number of points comprises the step of determining the first number of points based on the bet amount.

8. A method as defined in claim 1, further comprising the step of receiving a credit card number associated with a credit card account, wherein the step of subtracting the first number of points from a first game account comprises the step of charging the credit card account.

9. A method as defined in claim 1, wherein the step of subtracting the first number of points from a first game account comprises the step of subtracting the first number of points from a memory device associated with an Internet client.

10. A method as defined in claim 1, wherein the step of subtracting the first number of points from a first game account comprises the step of subtracting the first number of points from a memory device associated with a handheld electronic device.

11. A method as defined in claim 1, further comprising the step of receiving a bet multiplier, wherein the step of subtracting the first number of points from a first game account comprises the step of adjusting the first number of points based on the bet multiplier.

12. A method as defined in claim 11, wherein the step of adjusting the first number of points based on the bet multiplier comprises the step of retrieving digital representation of the bet multiplier from a digital memory, the digital representation representing a bet doubler.

13. A method as defined in claim 1, further comprising the steps of determining a maximum payout number and reducing the first number of points to be lower than the maximum payout number.

14. A wagering apparatus comprising:
a keyboard;
a display;
a memory storing a software program, a first player account and a second player account; and
a processor operatively coupled to the keyboard, display, and memory, the processor being structured to execute the software program, the software program being structured to cause the processor to:
(i) present data on the display indicative of an amount associated with the first player account and an amount associated with the second player account;
(ii) receive a first risk percentage from the keyboard;
(iii) determine a second risk percentage such that the sum of the first risk percentage and the second risk percentage is equal to 100%;
(iv) receive scaling data indicative of at least one of a scaling type and a scaling factor;
(v) determine a first number of points based on the scaling data and the first risk percentage;
(vi) determine a second number of points based on the scaling data and the second risk percentage;
(vii) receive a position indicator from the keyboard, the position indicator identifying an association between the first player account and the first risk percentage;
(viii) receive an outcome indicator from the keyboard, the outcome indicator identifying the first risk percentage as a winning position;
(ix) subtract an amount from the second player account; and
(x) add the amount to the first player account.

15. A wagering apparatus as defined in claim 14, wherein the software program is further structured to cause the processor to present a plurality of bet statements on the display and receive a selection identifying a particular bet statement from the plurality of bet statements from the keyboard.

16. A wagering apparatus as defined in claim 14, wherein the software program is further structured to cause the processor to receive a text based bet statement from the keyboard.

17. A wagering apparatus as defined in claim 14, wherein the software program is further structured to cause the processor to receive a first password associated with the first player account and a second password associated with the second player account.

18. A wagering apparatus as defined in claim 14, wherein the software program is further structured to cause the processor to receive a bet multiplier which affects the amount subtracted from the second player account.

19. A wagering apparatus structured for use via a computer network, the wagering apparatus comprising:
a transmitter operatively coupled to the computer network;
a receiver operatively coupled to the computer network;
a memory device;
an account manager operatively coupled to the transmitter, the receiver, and the memory device, the account manager being structured to store first player account data and second player account data in the memory device, the account manager being structured to retrieve the first player account data and the second player account data from the memory device, the account manager being structured to cause the transmitter to transmit the first player account data and the second player account data over the computer network;
a bet manager operatively coupled to the receiver, the memory device, and the account manager, the bet manager being structured to receive a first risk percentage from the receiver, the bet manager being structured to determine a second risk percentage such that the sum of the first risk percentage and the second risk percentage is substantially 100%, the bet manager being structured to store the first risk percentage and the second risk percentage in the memory device, the bet manager being structured to determine an amount based on a predetermined scaling algorithm, the bet manager being structured to receive a position indicator from the receiver, the position indicator identifying an association between the first player account data and the first risk percentage, the bet manager being structured to receive an outcome indicator from the receiver, the outcome indicator identifying the first risk percentage as a winning position, the bet manager being structured to cause the account manager to subtract the amount from the second player account and add the amount to the first player account in response to receiving the outcome indicator from the receiver.

20. A wagering apparatus as defined in claim 19, further comprising a bet statement manager operatively coupled to the transmitter, the receiver and the memory device, the bet statement manager being structured to receive a bet statement from the receiver, the bet statement manager being structured to store the bet statement in the memory, the bet statement manager being structured to retrieve the bet statement from the memory, the bet statement manager being structured to cause the transmitter to transmit the bet statement over the computer network.

21. A wagering apparatus as defined in claim 20, wherein the bet statement is a text based bet statement.

22. A wagering apparatus as defined in claim 19, further comprising an authorization module operatively coupled to the receiver, the authorization module being structured to receive a user name and a password associated with the first player account data.

23. A computer readable medium storing a software program, the software program being structured to cause a computing device to transfer points from a first player's game account to a second players game account by performing the steps of:
receiving data indicative of a first odds number, the first odds number representing a percentage of risk determined by the first player;
determining a second odds number such that the sum of the first odds number added to the second odds number is equal to 100%;
receiving scaling data indicative of at least one of a scaling type and a scaling factor;
determining a first number of points based on the scaling data and the first odds number;
determining a second number of points based on the scaling data and the second odds number;
receiving a position indicator, the position indicator representing an association between the second player and only one of the first odds number and the second odds number, the position indicator being selected by the second player;
receiving an outcome indicator, the outcome indicator representing a winning position, the winning position being associated with only one of the first odds number and the second odds number;
subtracting the first number of points from a first game account associated with the first player and adding the first number of points to a second game account associated with the second player if the position indicator is associated with the second odds number and the winning position is associated with the second odds number.

24. A computer readable medium as defined in claim 23, wherein the software program is further structured to cause the computing device to display a plurality of bet statements and receive a selection identifying a particular bet statement from the plurality of bet statements.

25. A computer readable medium as defined in claim 23, wherein the software program is further structured to cause the computing device to receive a text based bet statement.

26. A computer readable medium as defined in claim 23, wherein the software program is further structured to cause the computing device to:
receive a first user identifier associated with the first player;
receive a first password associated with the first player;
receive a second user identifier associated with the second player; and
receive a second password associated with the second player.

27. A computer readable medium as defined in claim 23, wherein the software program is further structured to cause the computing device to:
receive a first credit card number associated with a first credit card account; and
charge the first credit card account in proportion to the first number of points.

28. A computer readable medium as defined in claim 27, wherein the software program is further structured to cause the computing device to:
receive a second credit card number associated with a second credit card account; and
credit the second credit card account in proportion to the first number of points.

29. A computer readable medium as defined in claim 23, wherein the software program is further structured to cause the computing device to receive a bet multiplier, wherein the first number of points is proportional to the bet multiplier.

30. A method of game accounting, the method comprising the steps of:
receiving data indicative of a first odds number, the first odds number representing a percentage of risk determined by a first player;
determining a second odds number such that the sum of the first odds number added to the second odds number is substantially equal to 100%;
receiving an initial wager amount;
scaling the initial wager amount to create a final wager amount;
receiving a position indicator, the position indicator representing an association between a second player and the second odds number, the position indicator being selected by the second player;
receiving an outcome indicator, the outcome indicator indicating a win for the second player; and
rewarding the second player with the final wager amount.

31. A method as defined in claim 30, further comprising the steps of displaying a plurality of text based bet statements and receiving a selection identifying a particular text based bet statement from the plurality of text based bet statements.

32. A method as defined in claim 31, wherein the step of receiving data indicative of a first odds number comprises the step of receiving a whole number percentage.

33. A method as defined in claim 31, further comprising the step of receiving a bet rankings, wherein the step of rewarding the second player comprises the step of rewarding the second player with a number of points, the number of points being a multiple of the bet ranking.

34. A method as defined in claim 31, further comprising the step of timing a player action and awarding points for fast play.

35. A method as defined in claim 31, further comprising the step of receiving a plurality of position indicators from a plurality of players, wherein at least two of the position indicators indicate the same side of a bet for two different players.
